(19) United States
(12) Patent Application Publication
(10) Pub. No.: US 2024/0154196 A1
(43) Pub. Date: May 9, 2024

(54) BATTERY AND METHOD FOR MANUFACTURING BATTERY

(71) Applicant: Panasonic Intellectual Property Management Co., Ltd., Osaka (JP)

(72) Inventor: EIICHI KOGA, Hokkaido (JP)

(21) Appl. No.: 18/414,606

(22) Filed: Jan. 17, 2024

Related U.S. Application Data
(63) Continuation of application No. PCT/JP2022/022898, filed on Jun. 7, 2022.

(30) Foreign Application Priority Data
Aug. 5, 2021 (JP) 2021-129388

(51) Int. Cl. H01M 10/48; G01K 7/22

(52) U.S. Cl. CPC H01M 10/486; G01K 7/22

(57) ABSTRACT

A battery of the present disclosure includes: a first electrode; a second electrode; a solid electrolyte layer disposed between the first electrode and the second electrode; a temperature sensor; and a first lead-out terminal, in which the temperature sensor includes at least one selected from the group consisting of a thermistor and a resistance temperature detector, and is in contact with the first electrode, and the first lead-out terminal is in contact with the temperature sensor.

### BACKGROUND

### 1. Technical Field

The present disclosure relates to a battery and a method for manufacturing a battery.

### 2. Description of the Related Art

Japanese Unexamined Patent Application Publication No. 2009-272113 (hereinafter referred to as Patent Document 1) discloses an electric storage device including a temperature detection unit.

### SUMMARY

One non-limiting and exemplary embodiment provides a battery with improved reliability.

In one general aspect, the techniques disclosed here feature a battery including: a first electrode; a second electrode; a solid electrolyte layer disposed between the first electrode and the second electrode; a temperature sensor; and a first lead-out terminal, in which the temperature sensor includes at least one selected from the group consisting of a thermistor and a resistance temperature detector, and is in contact with the first electrode, and the first lead-out terminal is in contact with the temperature sensor.

The present disclosure provides a battery with improved reliability.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 includes a sectional view and a plan view illustrating a schematic configuration of a battery according to a first embodiment;

FIG. 2 includes a sectional view and a plan view illustrating a schematic configuration of a battery according to a second embodiment;

FIG. 3 includes a sectional view and a plan view illustrating a schematic configuration of a battery according to a third embodiment;

FIG. 4 includes a sectional view and a plan view illustrating a schematic configuration of a battery according to a fourth embodiment;

FIG. 5 includes a sectional view and a plan view illustrating a schematic configuration of a battery according to a fifth embodiment;

FIG. 6 includes a sectional view and a plan view illustrating a schematic configuration of a battery according to a sixth embodiment;

FIG. 7 includes a sectional view and a plan view illustrating a schematic configuration of a battery according to a seventh embodiment;

FIG. 8 includes a sectional view and a plan view illustrating a schematic configuration of a battery according to an eighth embodiment; and

FIG. 9 includes a sectional view and a plan view illustrating a schematic configuration of a battery according to a ninth embodiment.

### DETAILED DESCRIPTIONS

Embodiment of the present disclosure will be specifically described below with reference to the drawings.

Each embodiment described below represents a comprehensive or specific example. Numerical values, shapes, materials, layout positions and modes of connection of constituents, manufacturing procedures, the order of the manufacturing procedures, and the like discussed in the following embodiments are mere examples and are not intended to restrict the scope of the present disclosure.

In the present specification, terms that represent relations between elements as typified by parallelism, terms that represent shapes of the elements as typified by a rectangle, and numerical ranges are not only expressions that represent precise meanings but are also expressions that encompass substantially equivalent ranges with allowances of several percent, for example.

The respective drawings are schematic diagrams and are not always illustrated precisely. Accordingly, scales and other factors do not always coincide with one another in the respective drawings, for example. Moreover, in the respective drawings, structures that are substantially the same are denoted by the same reference signs and overlapping explanations thereof will be omitted or simplified.

In the present specification and the drawings, x axis, y axis, and z axis represent three axes of a three-dimensional orthogonal coordinate system. In each embodiment, z-axis direction is defined as a thickness direction of a battery. Meanwhile, in the present specification, the “thickness direction” means a direction perpendicular to laminated surfaces of respective layers in the battery.

In the present specification, the “plan view” means a case of viewing the battery along a direction of lamination in the battery. In the present specification, the “thickness” is a length in the direction of lamination in the battery element and of respective layers therein.

Regarding terms “inner” and “outer” as seen in an “inner side”, an “outer side”, and the like in the present specification, a center side of the battery is “inner” and a peripheral edge side of the battery is “outer” when the battery is viewed in the direction of lamination in the battery.

In the present specification, terms “on” and “below” concerning the configuration of the battery do not represent an upward direction (vertically upward) or a downward direction (vertically downward) in light of absolute spatial recognition, but are used as terms to be defined depending on a relative positional relationship based on the order of lamination in a laminated structure. Moreover, the terms “on” and “below” are used not only in a case where two constituents are disposed with an interval therebetween and another constituent is present between these two constituents, but also in a case where two constituents are disposed close to each other and the two constituents are in contact with each other.

### First Embodiment

A battery according to a first embodiment will be described below.

A battery according to the first embodiment includes: a first electrode; a second electrode; a solid electrolyte layer disposed between the first electrode and the second electrode; a temperature sensor; and a first lead-out terminal. The temperature sensor includes at least one selected from the group consisting of a thermistor and a resistance temperature detector, and is in contact with the first electrode. The first lead-out terminal is in contact with the temperature sensor.

According to the above-described configuration, a detection result at high accuracy and high responsiveness is obtained because a temperature of a battery operator can be directly monitored. For this reason, the battery can be securely and promptly shut off from an external circuit in a case where abnormal heat generation occurs in the battery. As a consequence, it is possible to suppress degradation of performances and reliability (such as a battery life) of the battery. Moreover, it is also possible to keep the battery from catching fire or generating smoke. In addition, it is possible to suppress deterioration of characteristics and abnormal heat generation of the battery as a consequence of dissipation of the heat in the battery through the lead-out terminal. Therefore, according to the battery of the first embodiment, the battery can achieve high reliability even in a case where the battery has a low profile and a large area, and requires a high degree of safety. In other words, it is possible to realize a battery having a large size and a low profile with a high degree of safety.

As discussed in the chapter “Description of the Related Art”, Patent Document 1 discloses the electric storage device including the temperature detection unit. However, the temperature detection unit that corresponds to the temperature sensor of the battery according to the first embodiment has a structure which is covered with an insulating resin having high thermal resistance and is in contact with a power generating element with the resin interposed therebetween, for example. Therefore, this temperature detection unit has problems of responsiveness in detecting the temperature, and of temperature accuracy. Meanwhile, since the temperature detection unit is covered with the resin, this resin is prone to degeneration and breakage due to degradation over time. Accordingly, the electric storage device disclosed in Patent Document 1 also has a problem of reliability.

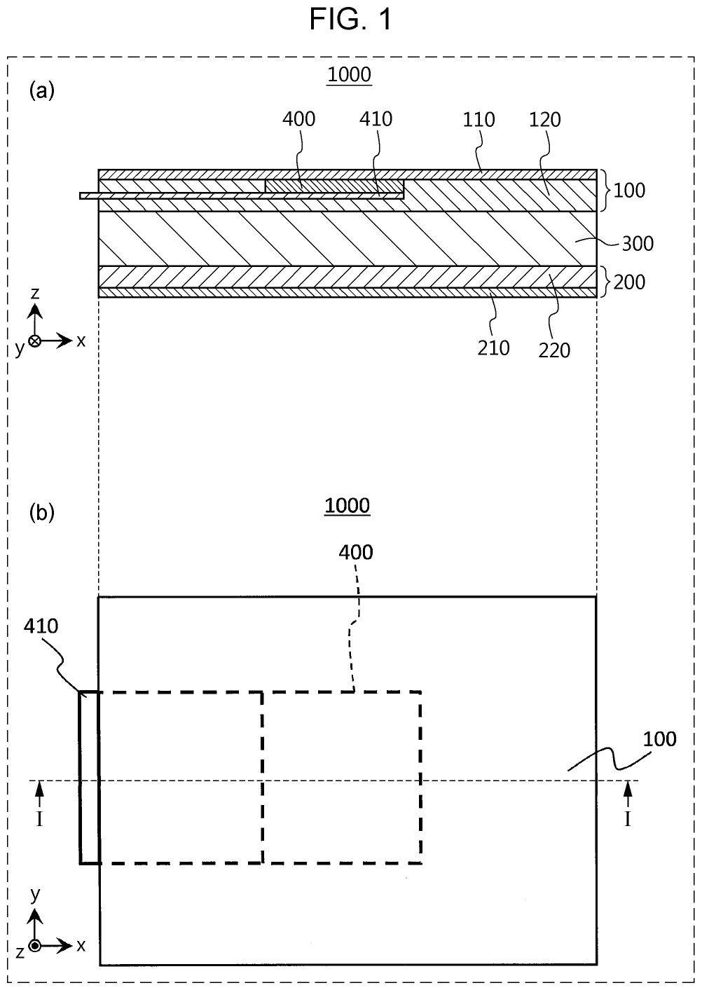

FIG. 1 includes a sectional view and a plan view illustrating a schematic configuration of the battery according to the first embodiment.

FIG. 1(a) is a sectional view of a battery 1000 according to the first embodiment. FIG. 1(b) is a plan view of the battery 1000 according to the first embodiment, which is viewed from an upper side in the z-axis direction. FIG. 1(a) illustrates a section at a position indicated with the I-I line in FIG. 1(b).

As illustrated in FIG. 1, the battery 1000 includes a first electrode 100, a second electrode 200, a solid electrolyte layer 300, a thermistor 400 provided as a temperature sensor, and a first lead-out terminal 410.

Here, the thermistor is discussed as an example of the temperature sensor. However, the temperature sensor is not limited to the thermistor. The temperature sensor may include a resistance temperature detector. The resistance temperature detector contains platinum, for example.

The solid electrolyte layer 300 is disposed between the first electrode 100 and the second electrode 200. The solid electrolyte layer 300 may be in contact with both the first electrode 100 and the second electrode 200.

The thermistor 400 is in contact with the first electrode 100. The thermistor 400 is desirably in direct contact with the first electrode 100 so as to be able to detect a temperature of a battery operator at higher accuracy and higher responsiveness, for example. Specifically, the thermistor 400 is disposed in contact with the first electrode 100 without interposing another member such as a protection film in between, for example.

The first lead-out terminal 410 is in contact with the thermistor 400.

The battery 1000 is an all-solid-state battery, for example.

The first electrode 100 includes a first current collector 110 and a first active material layer 120, for example.

The second electrode 200 includes a second current collector 210 and a second active material layer 220, for example.

In the battery 1000 according to the first embodiment, the thermistor 400 may be in contact with the first current collector 110, for example. A principal surface of the thermistor 400 may be in contact with the first current collector 110, for instance. The thermistor 400 may be in direct contact with the first current collector 110, for example. The first current collector 110 may double as a terminal of the thermistor 400 serving as the temperature sensor. Here, the terminal of the temperature sensor means a terminal for picking up a signal from the temperature sensor. In this case, the first lead-out terminal 410 may be in contact with another principal surface of the thermistor 400. According to these configurations, it is possible to detect the temperature of the battery operator at higher accuracy and higher responsiveness, and to reduce an increase in thickness of the battery 1000 associated with provision of the temperature sensor. Therefore, it is possible to realize a large-sized and low-profile battery having a high degree of safety.

In the battery 1000 according to the first embodiment, the thermistor 400 may be electrically coupled to the first current collector 110. According to this configuration as well, the first current collector 110 can be used as the terminal of the thermistor 400 serving as the temperature sensor.

The thermistor 400 includes an operator of which electric resistance varies with a change in temperature. The change in temperature of the battery 1000 can be detected by measuring a variation in electric resistance of the operator.

The operator of the thermistor 400 may be contained in the first electrode 100 and in contact with the first electrode 100. In other words, the operator of the thermistor 400 need not be exposed out of the first electrode 100. According to the above-described configuration, the change in temperature in the vicinity of the first active material layer 120 that is prone to heat generation can be measured more accurately and at higher responsiveness. As a consequence, it is easier to keep the battery 1000 from catching fire or generating smoke.

The thermistor 400 may be contained in the first electrode 100. That is to say, the entire thermistor 400 need not be exposed out of the first electrode 100. The above-described configuration can reduce an influence of heat dissipation from a surface of the thermistor 400, thus enabling the temperature measurement at higher accuracy and higher responsiveness. Moreover, it is possible to measure the heat generated inside the first electrode 100. This makes it possible to monitor the heat generation by the battery 1000 accurately and promptly, and it is easier to keep the battery 1000 from catching fire or generating smoke. Furthermore, the heat generated by the first electrode 100 can be released from the first lead-out terminal 410 to the outside of the battery. Thus, it is possible to suppress deterioration of characteristics and abnormal heat generation.

The thermistor 400 may be disposed at the center of the first electrode 100. In this case, an outer peripheral side surface of the thermistor 400 is in contact with the first active material layer 120 and is not exposed, for example. According to the above-described configuration, it is possible to measure a region of the battery 1000 which is prone to heat generation, and it is therefore easier to keep the battery 1000 from catching fire or generating smoke. Moreover, the heat that is generated at the center and is hard to be dissipated can be released through the first lead-out terminal 410.

A schematic shape in plan view of each of the first current collector 110, the first active material layer 120, the solid electrolyte layer 300, the second active material layer 220, the second current collector 210, and the thermistor 400 may be a rectangle. This shape does not always have to be the rectangle.

In FIG. 1, the first current collector 110, the first active material layer 120, the solid electrolyte layer 300, the second active material layer 220, and the second current collector 210 have the same size as one another and contours of the respective constituents coincide with one another in plan view. However, the present disclosure is not limited to this configuration.

The first active material layer 120 may be smaller than the second active material layer 220.

The first active material layer 120 and the second active material layer 220 may be smaller than the solid electrolyte layer 300.

In the case where the solid electrolyte layer 300 convers at least one of the first active material layer 120 and the second active material layer 220, for example, part of the solid electrolyte layer 300 may be in contact with at least one of the first current collector 110 and the second current collector 210.

Part of the thermistor 400 may be exposed to the outside of the first electrode 100.

The thermistor 400 may be in contact not only with the first electrode 100 but also with the solid electrolyte layer 300. Meanwhile, the thermistor 400 may be disposed in contact with the second electrode 200 in addition to the solid electrolyte layer 300.

The battery 1000 may include two or more thermistors. For example, the battery 1000 may include two thermistors, and one of the thermistors may be disposed in contact with the first electrode 100 while the other thermistor may be disposed in contact with the second electrode 200.

The first electrode 100 may be a positive electrode. In this case, the second electrode 200 is a negative electrode. The first current collector 110 and the first active material layer 120 are a positive electrode current collector and a positive electrode active material layer, respectively. The second current collector 210 and the second active material layer 220 are a negative electrode current collector and a negative electrode active material layer, respectively. According to the above-described configuration, the temperature in the region (namely, the positive electrode) in the battery 1000 which is prone to heat generation can be measured accurately and at high responsiveness. This makes it easier to keep the battery 1000 from catching fire or generating smoke.

The first electrode 100 may be the negative electrode while the second electrode 200 may be the positive electrode.

In the following description, the first current collector 110 and the second current collector 210 may be collectively referred to as a simple “current collector” as appropriate. The first active material layer 120 and the second active material layer 220 may be collectively referred to as a simple “active material layer” as appropriate.

The current collector only needs to be formed from a material having conductivity.

The current collector can adopt a foil-like body, a plate-like body, a mesh-like body, and the like formed from stainless steel, nickel (Ni), aluminum (Al), iron (Fe), titanium (Ti), copper (Cu), palladium (Pd), gold (Au), platinum (Pt), and an alloy of two or more types of the above-mentioned metal elements, for example.

The material of the current collector can be selected in consideration of a manufacturing process, a used temperature, a used pressure, a battery operation potential to be applied to the current collector, or conductivity. Moreover, the material of the current collector can also be selected in consideration of tensile strength or heat resistance required in the battery. The current collector may be a high-strength electrolytic copper foil or a clad material obtained by laminating different types of metal foils.

The current collector may have a thickness greater than or equal to 10 μm and less than or equal to 100 μm, for example.

A surface of the current collector may be processed into a roughened surface with asperities in order to increase adhesion to the active material layer (namely, the first active material layer 120 or the second active material layer 220). Accordingly, a bonding performance of an interface of the current collector is enhanced whereby mechanical and physical reliability and cycle characteristics of the battery 1000 are improved, for example. Meanwhile, electric resistance is reduced because of an increase in contact area between the current collector and the active material layer.

The first active material layer 120 may be in contact with the first current collector 110. The first active material layer 120 may cover the entire principal surface of the first current collector 110.

The positive electrode active material layer contains a positive electrode active material.

The positive electrode active material is a material designed to insert or extract metal ions such as lithium (Li) ions and magnesium (Mg) ions into or out of a crystal structure at a higher electric potential than that of the negative electrode, and to carry out oxidation or reduction in association therewith.

The positive electrode active material is a compound containing lithium and a transition metal element, for example. This compound is an oxide containing lithium and the transition metal element or a phosphate compound containing lithium and the transition metal element, for example.

Examples of the oxide containing lithium and the transition metal element include a lithium nickel composite oxide such as LiNiₓM₁₋ₓO₂ (in which M is at least one element selected from the group consisting of Co, Al, Mn, V, Cr, Mg, Ca, Ti, Zr, Nb, Mo, and W and x satisfies 0<x≤1), a layered oxide such as lithium cobaltate (LiCoO₂), lithium nickelate (LiNiO₂), and lithium manganate (LiMn₂O₄), and lithium manganate (LiMn₂O₄, Li₂MnO₃, or LiMO₂, for example) having a spinel structure.

Lithium iron phosphate (LiFePO₄) having an olivine structure is an example of the phosphate compound containing lithium and the transition metal element.

The positive electrode active material may adopt sulfur (S) or a sulfide such as lithium sulfide (Li₂S). In this case, lithium niobate (LiNbO₃) and the like may be coated on or added to positive electrode active material particles.

The positive electrode active material may adopt only one of these materials or a combination of two or more of these materials.

In addition to the positive electrode active material, the positive electrode active material layer may contain a material other than the positive electrode active material in order to increase lithium ion conductivity or electronic conductivity. Specifically, the positive electrode active material layer may be a mixture layer. Examples of this material include a solid electrolyte such as an inorganic solid electrolyte and a sulfide-based solid electrolyte, a conductive assistant such as acetylene black, and a binder such as polyethylene oxide and polyvinylidene fluoride.

The first active material layer 120 may have a thickness greater than or equal to 5 μm and less than or equal to 300 μm.

The thermistor 400 may have a thickness greater than or equal to 10 μm and less than or equal to 1000 μm.

At least part of the first lead-out terminal 410 extends to a side surface of the battery 1000 and an end portion thereof is exposed. Accordingly, the temperature can be monitored by measuring a resistance value between the first current collector 110 that may function as a terminal of the thermistor 400 and the first lead-out terminal 410 (that is to say, both ends of the thermistor 400).

At least part of a surface of the first lead-out terminal 410 may be roughened. A difference in level of asperities on such a roughened surface, namely, a maximum height roughness Rz (JIS B0601: 2013) may be in a range from 0.5 μm to 5 μm, for example. This can be nearly the same as the size of thermistor particles. In this way, bonding between the thermistor 400 to either the first electrode 100 or the first active material layer 120 is strengthened by an anchoring action. Accordingly, reliability of the bonding performance between the thermistor 400 and the first electrode 100 is increased. As a consequence, long-term stability of temperature accuracy and responsiveness is improved.

A material of the first lead-out terminal 410 may be a conductive metal.

Example of the conductive metal include Cu, Ag, Pd, Pt, and Au. These metal elements have high electric conductivity.

A thickness of the first lead-out terminal 410 may be greater than or equal to 0.5 μm and less than or equal to 100 μm.

The first lead-out terminal 410 may be thinner than the thermistor 400. This configuration makes it possible to reduce a thermal shock due to a difference in thermal expansion coefficient between a conductor layer constituting the first lead-out terminal 410 and the material of the thermistor attributable to a cooling cycle. As a consequence, it is possible to suppress delamination of the thermistor 400 from the conductor layer constituting the first lead-out terminal 410 or to suppress occurrence of cracks in the thermistor 400. Accordingly, this configuration improves measurement accuracy and reliability.

The thermistor 400 is formed from a material having electric resistance being a negative temperature coefficient (an NTC property). In other words, the thermistor 400 may be an NTC thermistor.

The thermistor 400 may include a ceramic material. In this way, the battery 1000 according to the first embodiment can incorporate the thermistor having excellent reliability, which is operable in a wide temperature range. In the meantime, in the lamination process of the battery 1000, for example, the battery 1000 can incorporate the thermistor 400 in the form of a thick-film thermistor by green compact formation (that is, a coating process). Alternatively, it is possible to embed the thermistor 400 in the form of a plate-like ceramic sintered element. Accordingly, the battery 1000 can incorporate the thermistor 400 in the battery forming process. Thus, it is possible to realize the battery that incorporates the thermistor, which is excellent in productivity.

The ceramic material may be an oxide ceramic. In other words, the thermistor 400 may contain an oxide ceramic. This configuration improves resistance to high temperature as well as chemical stability, thus obtaining high characteristic stability regarding oxidation-reduction reactions in power generating elements at the time of heat generation and during a battery operation. As a consequence, it is possible to conduct the temperature measurement in the battery based on high reliability.

For example, the oxide ceramic may be a transition metal oxide containing at least one selected from the group consisting of Ni, Mn, Co, and Fe.

The thermistor 400 can adopt an NTC thermistor composition using an oxide semiconductor ceramic material. The thermistor 400 can adopt a composite oxide including any of Mn—Ni—Co-based, Mn—Ni—Co—Fe, Mn—Ni—Co—Cr, Co—Cu—Ni, Co—Cu—Li, Co—Cu—Ni—Li, Co—Cu—Ni—Si, Mn—Ni—Cr, Mg—Al—Cr, and La—Co-based compositions, for example. As mentioned above, the thermistor 400 may be formed from the ceramic material containing the transition metal oxide.

The transition metal oxide may contain a crystal phase having a spinel structure as a major component. This configuration improves the resistance to high temperature and the chemical stability, thus obtaining high characteristic stability of oxidation and reduction at the time of heat generation and during the battery operation. Meanwhile, this configuration enables control of a resistance value and a thermistor constant of the thermistor 400 in wide ranges, and therefore enables measurement in a temperature range depending on the intended usage. Here, the thermistor constant is a temperature gradient coefficient of resistance, which will be hereinafter referred to as a “B constant”.

The material of the thermistor 400 may have room temperature specific resistance from 1000 Ω·cm to 3000 Ω·cm (25° C.) and the B constant from about 3000 K to 6000 K (between 25° C. and 50° C., for example). A resistance value of the material having the large B constant has a large temperature dependency, so that the material can be used for improving temperature detection accuracy.

Thermistors having different characteristics may be used in combination. This configuration makes it possible to adjust the resistance value or the B constant depending on the intended usage.

A typical active material contained in the active material layer is an oxide containing a transition metal element (Co, Mn, or Ni, for example) in many cases. Accordingly, the thermistor containing the transition metal oxide has thermal expansion characteristics close to those of electrode materials, so that the thermistor can suppress structural defects (such as cracks) that may be caused by the cooling cycle and the like. As a consequence, the thermistor 400 can perform temperature sensing at high reliability even when the thermistor 400 is contained in the first electrode 100.

When the thermistor 400 is formed from the oxide ceramic, the thermistor 400 is generally synthesized by sintering at a temperature from about 1000° C. to 1400° C. For this reason, the thermistor 400 remains stable and has high heat resistance even at a temperature (higher than or equal to 500° C., for example) that may cause burnout of the battery.

High-temperature stability of the thermistor 400 can be determined by subjecting a thermistor element (such as a sintered body and a pulverulent body) to a heat treatment in a used temperature range, for example, and checking changes in characteristics or a change in state thereof, the presence or absence of cracks, or a thermal analysis (TG-DTA). In general, the high-temperature stability barely changes at a temperature lower than a heat treatment temperature. Here, the changes in characteristics include changes of the resistance value and the B constant, for example. Meanwhile, the change in state includes a change of the crystal phase, for example. The change of the crystal phase is checked by X-ray diffraction (XRD). The presence or absence of cracks is checked with an optical microscope, a scanning electron microscope (SEM), and the like. Here, an approximate heat treatment temperature is determined by finding out the composition of the thermistor. The composition of the thermistor can be measured by an X-ray fluorescence (XRF) analysis or with an energy-dispersive X-ray spectroscope (EDS). The material of the thermistor is based on the material receiving small effects from trace additives. Accordingly, a composition analysis such as the EDS is sufficient for rough estimation of a heat treatment temperature of the thermistor.

The material of the thermistor 400 may be any of sintered bulk, a green compact structure formed from particles obtained by pulverizing the sintered composition, or a material coated into a thick film. The thermistor obtained by coating into the thick film may adopt a material such as a binder including polyethylene oxide, polyvinylidene fluoride, butyral resin, and the like. Meanwhile, the material may contain a substance that functions as a plasticizing agent as typified by benzyl butyl phthalate (BBP) or dibutyl phthalate (DBP). In this way, a bonding performance with a surrounding material is strengthened in conformity to asperities on a green compact body structure, a conductor electrode layer, and the like, so that structural defects can be reduced.

The second active material layer 220 may be in contact with the second current collector 210. The second active material layer 220 may cover the entire principal surface of the second current collector 210.

The negative electrode active material layer contains a negative electrode active material.

The negative electrode active material is a material designed to insert or extract metal ions such as lithium (Li) ions and magnesium (Mg) ions into or out of a crystal structure at a lower electric potential than that of the positive electrode, and to carry out oxidation or reduction in association therewith.

Examples of the negative electrode active material include a carbon material such as natural graphite, artificial graphite, graphite carbon fibers, and resin heat-treated carbon, or an alloy material that is formed into a mixture together with a solid electrolyte. Examples of the alloy material include a lithium alloy such as LiAl, LiZn, Li₃Bi, Li₃Cd, Li₃Sb, Li₄Si, Li_{4.4}Pb, Li_{4.4}Sn, Li_{0.17}C, and LiC₆, an oxide of lithium and a transition metal element such as lithium titanate (Li₄Ti₅O₁₂), and a metal oxide such as zinc oxide (ZnO) and silicon oxide (SiOₓ).

The negative electrode active material may adopt only one of these materials or a combination of two or more of these materials.

In addition to the negative electrode active material, the negative electrode active material layer may contain a material other than the negative electrode active material in order to increase lithium ion conductivity or electronic conductivity. Examples of this material include a solid electrolyte such as an inorganic solid electrolyte and a sulfide-based solid electrolyte, a conductive assistant such as acetylene black, and a binder such as polyethylene oxide and polyvinylidene fluoride.

The second active material layer 220 may have a thickness greater than or equal to 5 μm and less than or equal to 300 μm.

The solid electrolyte layer 300 includes a solid electrolyte. The solid electrolyte layer 300 contains the solid electrolyte as a major component, for example. The solid electrolyte layer 300 may consist of the solid electrolyte.

The solid electrolyte may be a publicly known solid electrolyte for battery use having ion conductivity. A solid electrolyte that conducts metal ions such as lithium ions and magnesium ions may be used as the solid electrolyte, for example.

An inorganic solid electrolyte such as a sulfide-based solid electrolyte or an oxide-based solid electrolyte may be used as the solid electrolyte, for instance.

Examples of the sulfide-based solid electrolyte include Li₂S—P₂S₅-based, Li₂S—SiS₂-based, Li₂S—B₂S₃-based, Li₂S—GeS₂-based, Li₂S—SiS₂—LiI-based, Li₂S—SiS₂—Li₃PO₄-based, Li₂S—Ge₂S₂-based, Li₂S—GeS₂—P₂S₅-based, and Li₂S—GeS₂—ZnS-based solid electrolytes.

Examples of the oxide-based solid electrolyte include a lithium-containing metal oxide, a lithium-containing metal nitride, lithium phosphate (Li₃PO₄), and a lithium-containing transition metal oxide. Examples of the lithium-containing metal oxide include Li₂O—SiO₂ and Li₂O—SiO₂—P₂O₅. Examples of the lithium-containing metal nitride include LiₓP_{y}O_{1-z}N_{z} and the like. Examples of the lithium-containing transition metal oxide include lithium titanium oxide and the like.

The solid electrolyte may adopt only one of the above-mentioned materials or a combination of two or more of these materials.

The solid electrolyte layer 300 main include a solid electrolyte having lithium ion conductivity.

In addition to the above-mentioned solid electrolyte, the solid electrolyte layer 300 may also contain a binder such as polyethylene oxide and polyvinylidene fluoride.

The solid electrolyte layer 300 may have a thickness greater than or equal to 5 μm and less than or equal to 150 μm.

The material of the solid electrolyte may be formed from an aggregate of particles. Alternatively, the material of the solid electrolyte may be formed from a sintered structure.

### Second Embodiment

A battery according to a second embodiment will be described below. Note that the matters that have been explained in the first embodiment may be omitted as appropriate.

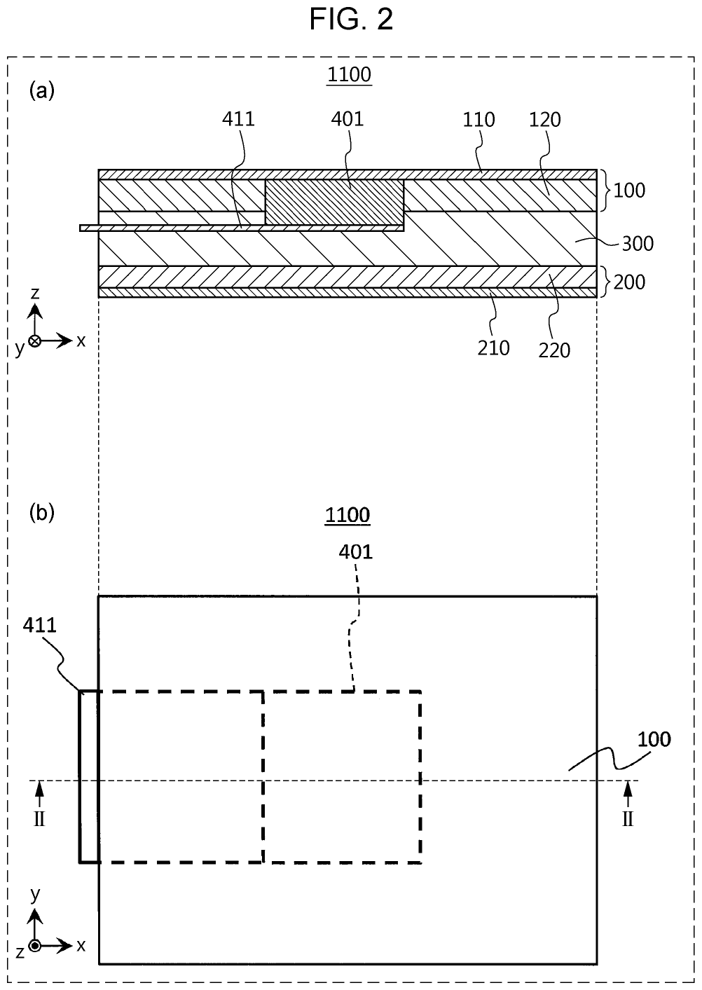

FIG. 2 includes a sectional view and a plan view illustrating a schematic configuration of the battery according to the second embodiment.

FIG. 2(a) is a sectional view of a battery 1100 according to the second embodiment. FIG. 2(b) is a plan view of the battery 1100 according to the second embodiment, which is viewed from an upper side in the z-axis direction. FIG. 2(a) illustrates a section at a position indicated with the II-II line in FIG. 2(b).

As illustrated in FIG. 2, in the battery 1100, a thermistor 401 is in contact not only with the first electrode 100 but also with the solid electrolyte layer 300.

The above-described configuration makes it possible to detect heat generation even when the first electrode 100 has a low profile. Accordingly, it is easier to keep the battery 1100 provided with the low-profile electrode from catching fire or generating smoke.

In the battery 1100 illustrated in FIG. 2, the thermistor 401 is in contact with the first current collector 110. A surface of the thermistor 401 located opposite to the surface in contact with the first current collector 110 is in contact with a first lead-out terminal 411. The thermistor 401 has a structure that can measure all temperatures in a thickness direction of the first electrode 100. To be more precise, the thermistor 401 is in contact with all thickness positions of the first electrode 100, for example. This configuration enables sensing of heat generation in the first electrode 100 promptly and at high accuracy. Therefore, according to the above-described configuration, it is possible to suppress deterioration of characteristics or burnout of the battery 1100. Thus, the battery 1100 has high reliability.

The thermistor 401 only needs to be in contact with the first electrode 100 and need not be in contact with the first current collector 110. Specifically, the first active material layer 120 may be disposed between the thermistor 401 and the first current collector 110.

The thermistor 401 may be thicker than the first active material layer 120.

In order to increase a bonding performance between the first lead-out terminal 411 and the solid electrolyte layer 300, a contact area of a principal surface of the first lead-out terminal 411 may be increased by providing asperities, for example. A metal material (such as Cu) with a surface subjected to surface roughening so as to bring about a difference in level of asperities thereon, namely, a maximum height roughness Rz (JIS B0601: 2013) around several micrometers may be used as the first lead-out terminal 411, for example. In order to increase a bonding performance between the thermistor 401 and the first lead-out terminal 411, at least part of the surface of the first lead-out terminal 411 may be roughened in such a way as to provide asperities in a range from 0.5 μm to 5 μm as described in conjunction with the first lead-out terminal 410 of the battery 1000 according to the first embodiment, for example.

A lead-out region of the first lead-out terminal 411 may be subjected to hole processing for anchor holes and the like so as to increase a bonding performance with surroundings. A shape of such a hole is not limited to a particular shape, and may be formed into a circular shape, an elliptical shape, or a rectangular shape, for example. By subjecting the first lead-out terminal 411 to the above-described hole processing, it is possible to increase reliability of the battery 1100 against a cooling cycle and the like.

### Third Embodiment

A battery according to a third embodiment will be described below. Note that the matters that have been explained in the above-described embodiments may be omitted as appropriate.

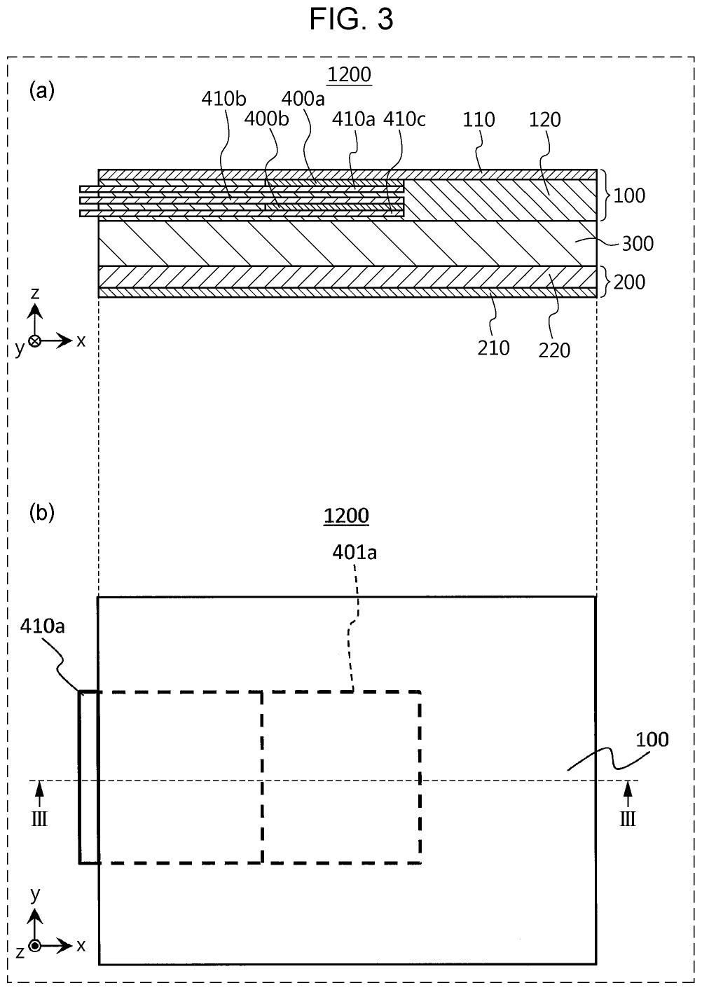

FIG. 3 includes a sectional view and a plan view illustrating a schematic configuration of the battery according to the third embodiment.

FIG. 3(a) is a sectional view of a battery 1200 according to the third embodiment. FIG. 3(b) is a plan view of the battery 1200 according to the third embodiment, which is viewed from an upper side in the z-axis direction. FIG. 3(a) illustrates a section at a position indicated with the III-III line in FIG. 3(b).

As illustrated in FIG. 3, the battery 1200 is different from the battery 1000 according to the first embodiment in that the battery 1200 includes more than one thermistor. As illustrated in FIG. 3, the battery 1200 includes two thermistors 400a and 400b in contact with the first electrode 100. The two thermistors 400a and 400b are disposed at thickness positions of the first electrode 100 which are different from each other. Moreover, the battery 1200 is provided with a first lead-out terminal 410a in contact with the thermistor 400a, and first lead-out terminals 410b and 410c in contact with the thermistor 400b. The thermistor 400a is in contact with the first current collector 110. The first current collector 110 also functions as a terminal of the thermistor 400a.

The above-described configuration makes it possible to monitor temperatures at different thickness positions in the first electrode 100 at high responsiveness and accuracy. Moreover, provision of the multiple first lead-out terminals improves a heat dissipation performance in the first electrode 100. As a consequence, the battery 1200 has high reliability.

Here, the thermistors to be provided to the battery 1200 are not limited to two thermistors, and three or more thermistors may be provided instead.

### Fourth Embodiment

A battery according to a fourth embodiment will be described below. Note that the matters that have been explained in the above-described embodiments may be omitted as appropriate.

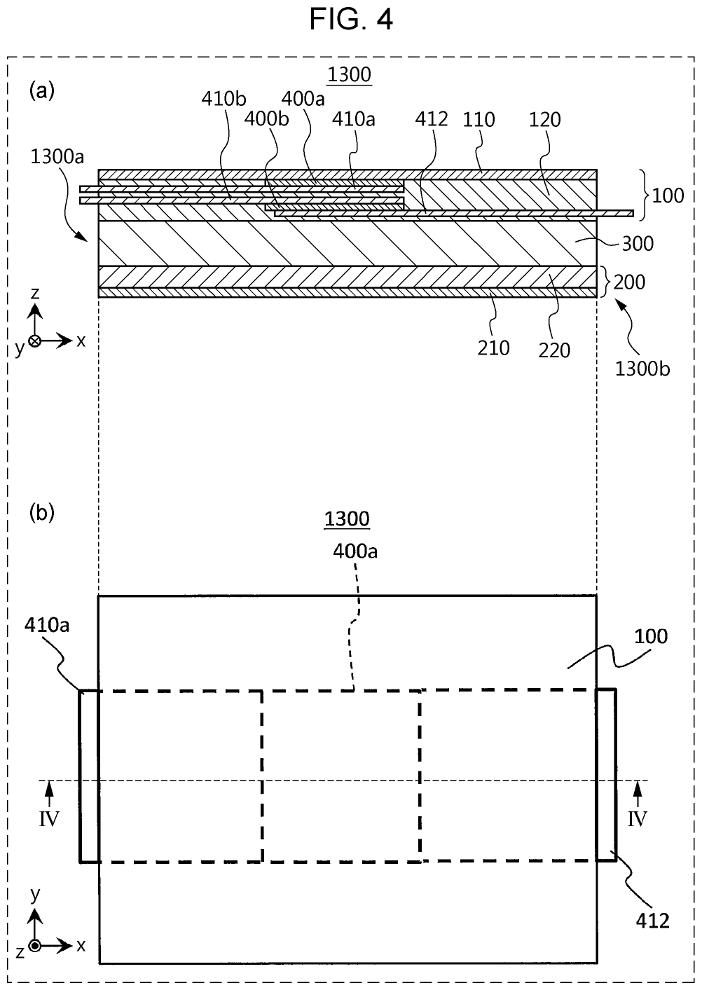

FIG. 4 includes a sectional view and a plan view illustrating a schematic configuration of the battery according to the fourth embodiment.

FIG. 4(a) is a sectional view of a battery 1300 according to the fourth embodiment. FIG. 4(b) is a plan view of the battery 1300 according to the fourth embodiment, which is viewed from an upper side in the z-axis direction. FIG. 4(a) illustrates a section at a position indicated with the Iv-Iv line in FIG. 4(b).

As illustrated in FIG. 4, the battery 1300 is different from the battery 1200 according to the third embodiment in that the battery 1300 includes a second lead-out terminal. As illustrated in FIG. 4, the battery 1300 includes the first lead-out terminals 410a and 410b, and a second lead-out terminal 412. The first lead-out terminals 410a and 410b are lead out toward a first side surface 1300a of the battery 1300. The second lead-out terminal 412 is lead out toward a second side surface 1300b of the battery 1300 being different from the first side surface 1300a thereof.

The above-described configuration makes it possible to release the heat generated in the battery 1300 to a wider range in a dispersed manner. As a consequence, deterioration of characteristics and abnormal heat generation of the battery 1300 can be suppressed more appropriately. The battery 1300 therefore has high reliability.

In order to increase the heat dissipation performance, the direction of leading out the second lead-out terminal 412 may be opposite to the direction of leading out the first lead-out terminals 410a and 410b. Specifically, the second side surface 1300b of the battery 1300 described above may be a surface opposed to the first side surface 1300a of the battery 1300.

### Fifth Embodiment

A battery according to a fifth embodiment will be described below. Note that the matters that have been explained in the above-described embodiments may be omitted as appropriate.

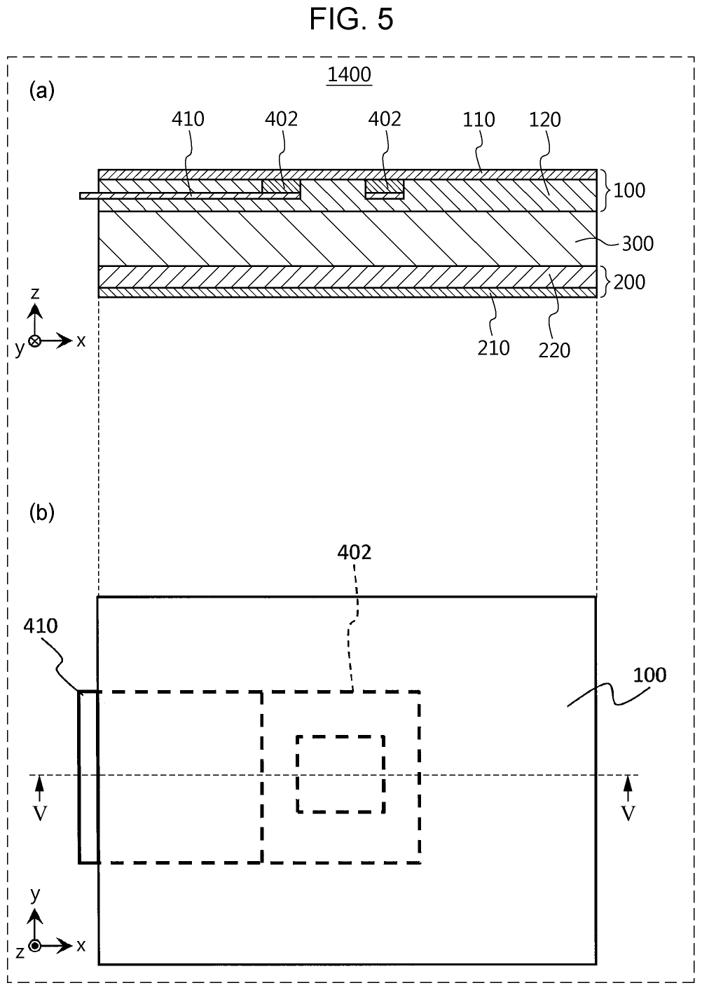

FIG. 5 includes a sectional view and a plan view illustrating a schematic configuration of the battery according to the fifth embodiment.

FIG. 5(a) is a sectional view of a battery 1400 according to the fifth embodiment. FIG. 5(b) is a plan view of the battery 1400 according to the fifth embodiment, which is viewed from an upper side in the z-axis direction. FIG. 5(a) illustrates a section at a position indicated with the V-V line in FIG. 5(b).

As illustrated in FIG. 5, the battery 1400 is different from the battery 1000 according to the first embodiment in that the thermistor has a different shape. The battery 1400 according to the fifth embodiment includes a thermistor 402 having a shape of a hollow frame. A hollow portion of the thermistor 402 is filled with the first active material layer 120. The first active material layer 120 filling the hollow portion of the thermistor 402 is in contact with the thermistor 402.

According to the above-described configuration, the heat generated in the first active material layer 120 located at the hollow portion of the thermistor 402 can be detected at high responsiveness and accuracy.

The hollow portion of the thermistor 402 may be located at the center of the first active material layer 120 in plan view. In this way, the thermistor 402 can be disposed so as to surround a portion near the center of the active material layer which is prone to heat generation. In addition, the contact area between the thermistor 402 and the first active material layer 120 is increased. As a consequence, the heat generation can be detected at high response and accuracy. The battery 1400 therefore has high reliability.

A shape of the hollow portion of the thermistor 402 need not be a rectangle. Other examples of the shape of the hollow portion of the thermistor 402 include a circle, a square, a polygon, a starburst, and a crisscross. In the meantime, an outer shape of a frame of the thermistor 402 is not limited to a rectangle, but may instead be any of a circle, a square, a polygon, a starburst, a crisscross, and the like.

### Sixth Embodiment

A battery according to a sixth embodiment will be described below. Note that the matters that have been explained in the above-described embodiments may be omitted as appropriate.

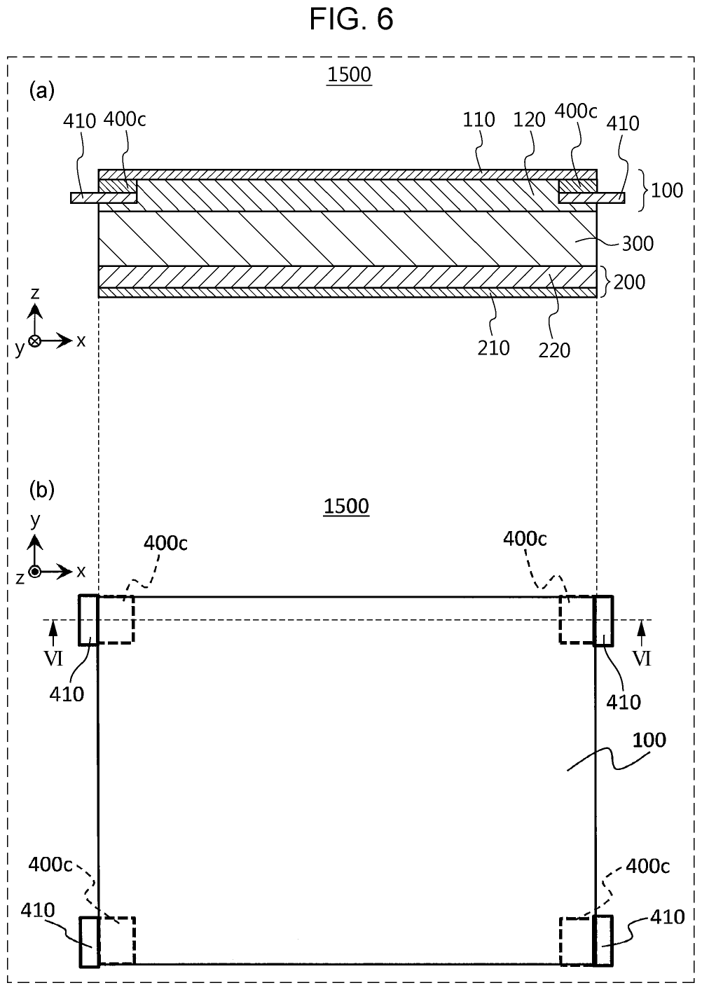

FIG. 6 includes a sectional view and a plan view illustrating a schematic configuration of the battery according to the sixth embodiment.

FIG. 6(a) is a sectional view of a battery 1500 according to the sixth embodiment. FIG. 6(b) is a plan view of the battery 1500 which is viewed from an upper side in the z-axis direction. FIG. 6(a) illustrates a section at a position indicated with the VI-VI line in FIG. 6(b).

As illustrated in FIG. 6, the battery 1500 is different from the battery 1000 according to the first embodiment in that positions to install the thermistors and the number of the thermistors are different. As illustrated in FIG. 6, the battery 1500 includes four thermistors 400c. The four thermistors 400c are disposed at four corners of the first electrode 100, respectively.

The above-described configuration makes it possible to monitor temperatures in the battery while protecting corner portions of the power generating element, which are prone to damage, by using the thermistors 400c. In other words, it is possible to improve resistance of the battery 1500 against an external stress, and moreover, to detect the heat generated in the battery 1500 at high responsiveness and accuracy. Accordingly, the battery 1500 has high reliability.

In FIG. 6, the thermistors 400c are disposed at all of the four corners of the first electrode 100. However, the present disclosure is not limited to this configuration. The thermistor 400c only needs to be disposed at least at one corner of the first electrode 100.

The thermistors 400c may be disposed not only at the corners of the first electrode 100 but also at corners of the second electrode 200.

A shape of each thermistor 400c is not limited to a particular shape. The shape of the thermistor 400c does not have to be a rectangle.

When the battery 1500 includes multiple thermistors 400c, the shapes and sizes of the thermistors 400c may be different from one another.

### Seventh Embodiment

A battery according to a seventh embodiment will be described below. Note that the matters that have been explained in the above-described embodiments may be omitted as appropriate.

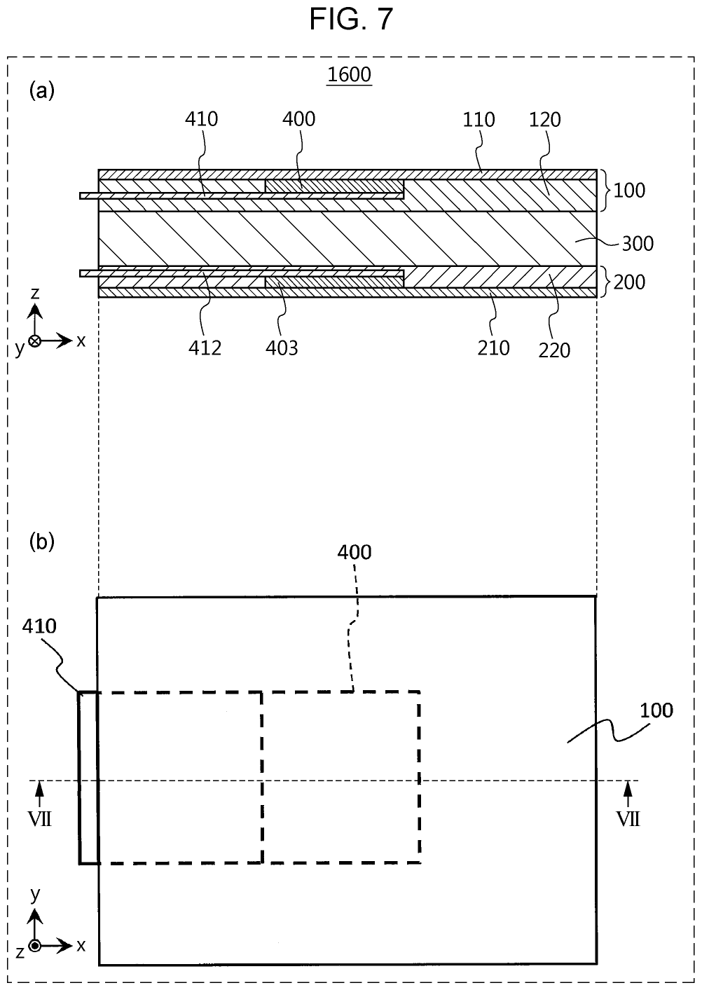

FIG. 7 includes a sectional view and a plan view illustrating a schematic configuration of the battery according to the seventh embodiment.

FIG. 7(a) is a sectional view of a battery 1600 according to the seventh embodiment. FIG. 7(b) is a plan view of the battery 1600 according to the seventh embodiment, which is viewed from an upper side in the z-axis direction. FIG. 7(a) illustrates a section at a position indicated with the VII-VII line in FIG. 7(b).

As illustrated in FIG. 7, the battery 1600 is different from the battery 1000 according to the first embodiment in that the battery 1600 further includes a thermistor 403 in contact with the second electrode 200. The thermistor 403 is in contact with the second current collector 210 of the second electrode 200, for example. Accordingly, the second current collector 210 can double as a terminal of the thermistor 403. Moreover, there is also provided the second lead-out terminal 412 in contact with the thermistor 403.

The above-described configuration makes it possible to detect heat generation even when the heat is generated in the second electrode 200. Thus, the battery 1600 can further improve reliability.

The thermistor that may be used as the thermistor 403 in contact with the second electrode 200 is the same as the thermistor 400 described in the first embodiment. The thermistor 403 in contact with the second electrode 200 may have a shape and a size which are different from those of the thermistor 400 in contact with the first electrode 100.

### Eighth Embodiment

A battery according to an eighth embodiment will be described below. Note that the matters that have been explained in the above-described embodiments may be omitted as appropriate.

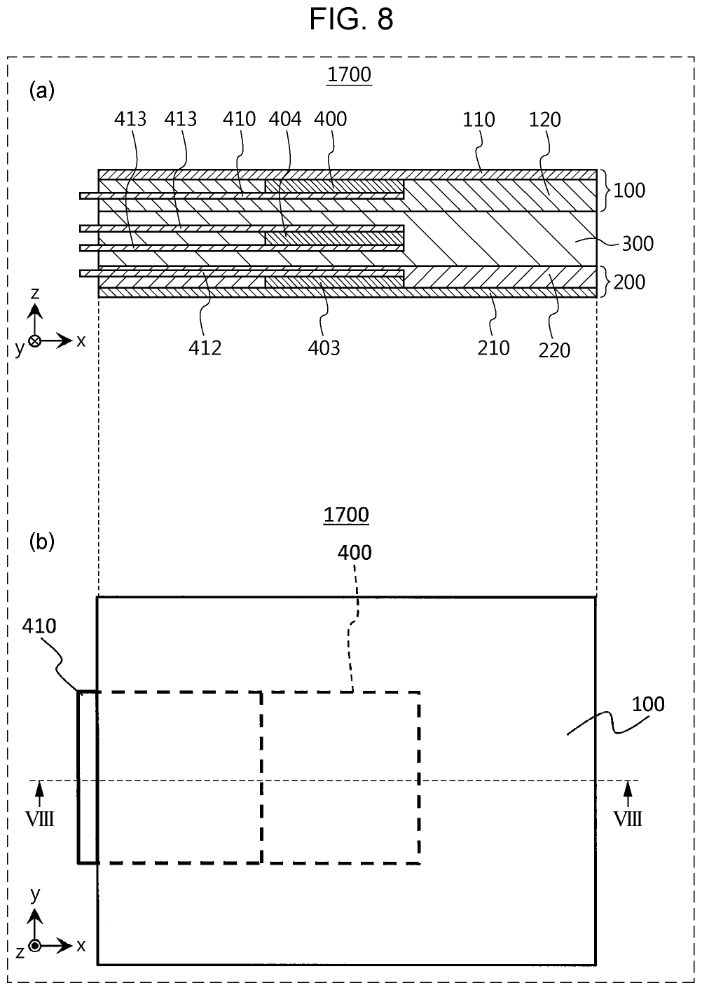

FIG. 8 includes a sectional view and a plan view illustrating a schematic configuration of the battery according to the eighth embodiment.

FIG. 8(a) is a sectional view of a battery 1700 according to the eighth embodiment. FIG. 8(b) is a plan view of the battery 1700 according to the eighth embodiment, which is viewed from an upper side in the z-axis direction. FIG. 8(a) illustrates a section at a position indicated with the VIII-VIII line in FIG. 8(b).

As illustrated in FIG. 8, in addition to the configuration of the battery 1600 according to the seventh embodiment, the battery 1700 further includes a thermistor 404 in contact with the solid electrolyte layer 300. Specifically, the battery 1700 includes the thermistors which are in contact with the first electrode 100, the second electrode 200, and the solid electrolyte layer 300, respectively. The battery 1700 further includes a lead-out terminal 413 in contact with the thermistor 404.

The above-described configuration makes it possible to detect heat generation when any one of the first electrode 100, the second electrode 200, and the solid electrolyte layer 300 generates heat in the battery 1700. In addition, more heat dissipation paths are provided in a wider range. Accordingly, the battery 1700 has higher reliability.

### Ninth Embodiment

A battery according to a ninth embodiment will be described below. Note that the matters that have been explained in the above-described embodiments may be omitted as appropriate.

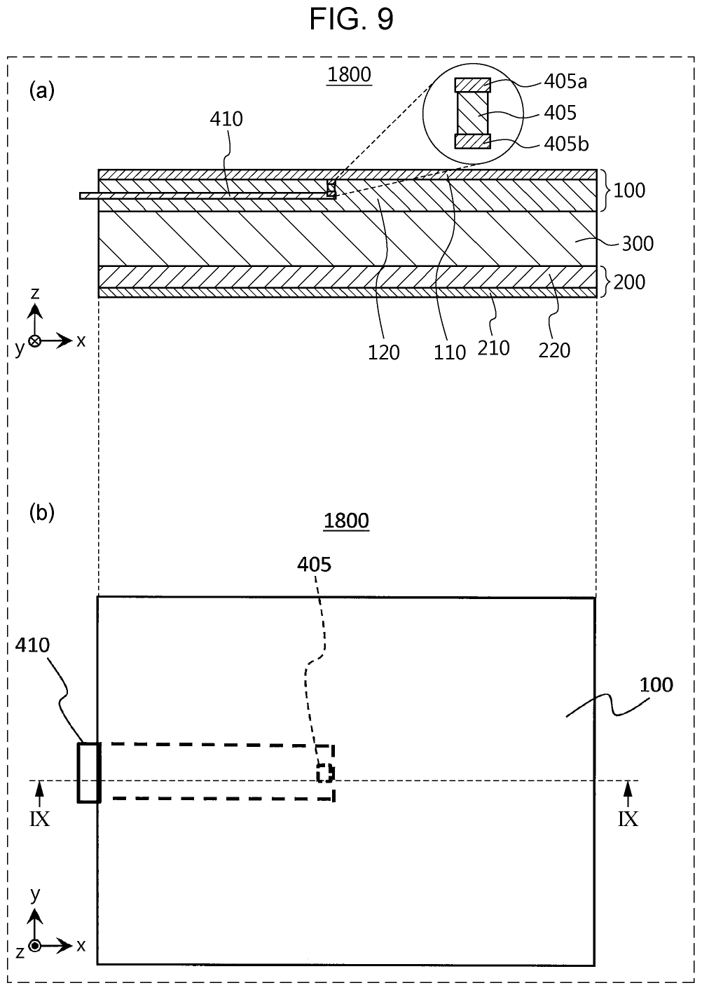

FIG. 9 includes a sectional view and a plan view illustrating a schematic configuration of the battery according to the ninth embodiment.

FIG. 9(a) is a sectional view of a battery 1800 according to the ninth embodiment. FIG. 9(b) is a plan view of the battery 1800 according to the ninth embodiment, which is viewed from an upper side in the z-axis direction. FIG. 9(a) illustrates a section at a position indicated with the IX-IX line in FIG. 9(b).

As illustrated in FIG. 9, the battery 1800 is different from the battery 1000 according to the first embodiment in that the thermistor is a chip-type laminated thermistor 405, or in other words, that the thermistor having a laminated structure is used therein.

The above-described configuration makes it possible to measure the temperature in the battery 1800 by using the thermistor that is small in size. As a consequence, the thermistor can be used while reducing an impact on a volumetric energy density of the battery 1800. Moreover, it is possible to realize the battery 1800 which incorporates the thermistor and is excellent in reliability by use of the chip-type laminated thermistor 405 being excellent in weather resistance and in deflection resistance.

The laminated thermistor 405 has a structure in which a thermistor material is disposed between electrodes opposed to each other, for example. Accordingly, the laminated thermistor 405 can control a resistance value of the thermistor in a wide range by way of an area of overlap of the electrodes and the thermistor material and a distance between the electrodes. As a consequence, the laminated thermistor 405 can perform adjustment to a desired resistance value that facilitates measurement and control.

The laminated thermistor 405 may include an inner electrode. By forming the inner electrode into a laminated structure like a laminated ceramic capacitor, the laminated thermistor 405 can control the resistance in a wider range. Moreover, in this case, it is also possible to increase heat dissipation paths by using the inner electrode. Therefore, according to this configuration, it is possible to increase temperature measurement sensitivity (in other words, responsiveness and accuracy) and also to suppress deterioration of characteristics and abnormal heat generation more effectively.

A publicly known component such as a chip element having a so-called 0603 size (0.6×0.3×0.3 mm) can be used as the laminated thermistor 405, for example.

Although a material of the laminated thermistor 405 is not limited to a particular material, this material may be a Mn—Co—Ni—Cu-based NTC thermistor material, for example.

A material of the inner electrode of the laminated thermistor 405 may be Pd, for example.

The inner electrode of the laminated thermistor 405 may have a thickness in a range from 0.5 μm to 3 μm, for example.

A material containing a glass component and Cu may be used for the electrodes of the laminated thermistor 405 in order to strengthen the bonding with the thermistor material. In this case, the glass component may be contained at a percentage in a range from 0.1% by mass to 5% by mass relative to Cu. In addition, the electrodes of the laminated thermistor 405 may be subjected to Ni/Sn plating for mounting solder. In the Ni/Sn plating, a thickness of Ni may be set in a range from 0.5 μm to 5 μm, for example, and a thickness of Sn may be set in a range from 1 μm to 10 μm, for example. In this way, it is possible to achieve electrical coupling between the laminated thermistor 405 and the current collector by using molten welder.

The shape of the laminated thermistor 405 is not limited to the 0603 size. The shape of the laminated thermistor 405 may be 0402 (0.4×0.2×0.2 mm), for example. A smaller shape of the laminated thermistor 405 can reduce an impact on a volumetric capacitance density.

In FIG. 9, the laminated thermistor 405 is disposed at the center of the first electrode 100. One of the electrodes (an electrode 405a) of the laminated thermistor 405 is in contact with the first current collector 110 and is electrically coupled thereto with solder. In order to establish bonding, a conductive resin may be used instead of the solder. The other electrode (an electrode 405b) may be lead out to a side surface of the battery 1800 through the first lead-out terminal 410.

### Method for Manufacturing Battery

For example, a method for manufacturing a battery according to the present disclosure includes,
fabricating a first electrode joined to a temperature sensor by forming the temperature sensor, a lead-out terminal in contact with the temperature sensor, and a first active material layer on a first current collector,
fabricating a second electrode,
forming a solid electrolyte layer on at least one electrode selected from the group consisting of the first electrode and the second electrode, and
joining the first electrode to the second electrode in such a way as to dispose the solid electrolyte in between.

The method for manufacturing a battery of the present disclosure will be specifically described below. Here, a method for manufacturing the battery 1000 according to the first embodiment will be described as an example.

The following description will explain the example in the case where the first electrode 100 is the positive electrode and the second electrode 200 is the negative electrode.

First, respective paste materials used for printing and forming the positive electrode active material layer, the negative electrode active material layer, and the thermistor are fabricated. Glass powder of a Li₂S—P₂S₅-based sulfide having an average grain size of about 10 μm and containing triclinic crystals as a main component is prepared as a solid electrolyte raw material to be used in respective mixtures for the positive electrode active material layer and the negative electrode active material layer, for example. This glass powder has ion conductivity in a range from 2×10⁻³ S/cm to 3×10⁻³ S/cm, for example. Powder of a Li·Ni·Co·Al composite oxide (such as LiNi_{0.8}Co_{0.15}Al_{0.05}O₂) of a layered structure having an average grain size of about 5 μm is used as the positive electrode active material, for example. The paste for the positive electrode active material layer is fabricated by dispersing the mixture containing the above-mentioned positive electrode active material and the above-mentioned glass powder into an organic solvent or the like. Natural graphite powder having an average grain size of about 10 μm is used as the negative electrode active material, for example. The paste for the negative electrode active material layer is fabricated by dispersing the mixture containing the above-mentioned negative electrode active material and the above-mentioned glass powder into an organic solvent or the like. Powder of Mn—Ni—Cr—Al-based oxide semiconductor NTC thermistor (having the specific resistance from 1 kΩ·cm to 3 kΩ·cm and the B constant from 4000 K to 5000 K, for example) having an average grain size of 3 μm is used as the material of the thermistor, for example. The thermistor paste is fabricated by dispersing this powder into the aforementioned organic solvent or the like.

Subsequently, copper foils having a thickness of about 30 μm are prepared as a positive electrode current collector layer and a negative electrode current collector layer, for example. The thermistor paste is printed in a predetermined thickness and a predetermined shape in accordance with a screen printing method on one of surfaces of the copper foil used as the positive electrode current collector layer. The thermistor paste is dried at a temperature in a range from 80° C. to 130° C. Subsequently, the same copper foil as the positive current collector is used as a lead-out electrode of the thermistor, and the first lead-out terminal is placed on a region from the principal surface of the thermistor to one side surface of the battery. Moreover, the paste for the positive electrode active material layer is printed in a predetermined thickness and a predetermined shape on the positive electrode current collector layer on which the thermistor and the first lead-out terminal are disposed, and the paste is dried at a temperature in the range from 80° C. to 130° C. Meanwhile, the paste for the negative electrode active material layer is printed in a predetermined thickness and a predetermined shape on one of surfaces of the copper foil used as the negative electrode current collector layer, and the paste is dried at a temperature in the range from 80° C. to 130° C. Each paste is printed in a thickness of about 50 μm to 100 μm, for example. The positive electrode provided with the thermistor, the first lead-out terminal, and the positive electrode active material layer on the positive electrode current collector, and the negative electrode provided with the negative electrode active material layer on the negative electrode current collector are thus formed.

Subsequently, paste for the solid electrolyte layer is formed by dispersing the above-described mixture containing the glass powder into an organic solvent or the like. The above-mentioned paste for the solid electrolyte layer is printed in a thickness of about 100 μm, for example, on the positive electrode and on the negative electrode by using a metal mask. Thereafter, the negative electrode as well as the positive electrode that contains the thermistor, on which the paste for the solid electrolyte layer is printed, are dried at a temperature in the range from 80° C. to 130° C.

Subsequently, the solid electrolyte printed on the positive electrode active material layer and the solid electrolyte printed on the negative electrode active material layer are laminated in such a way as to be opposed to and brought into contact with each other. A laminated body thus laminated is housed into a die having a rectangular external shape, for example.

Subsequently, an elastic body sheet having a thickness of 70 μm and an elastic modulus of about 5×10⁶ Pa is inserted between a pressure mold punch and the laminated body. A pressure is applied to the laminated body through the elastic body sheet by this configuration. Thereafter, the pressure is applied for 90 seconds while heating the pressure mold up to 50° C. at a pressure of 300 MPa. Accordingly, the battery is obtained by laminating the positive electrode containing the thermistor, the solid electrolyte layer, and the negative electrode.

Note that the method for manufacturing the battery and the order of the procedures thereof are not limited to the above-described example.

The above-described manufacturing method has described the example of applying the paste for the positive electrode active material layer, the paste for the thermistor, the paste for the negative electrode active material layer, and the paste for the solid electrolyte layer by printing. However, the present disclosure is not limited to this process. As for the printing method, a doctor blade method, a calendar method, a spin-coating method, a dip-coating method, an inkjet method, an offset method, a die-coating method, a spray method, and the like may be used, for example.

The battery of the present disclosure has been described based on the embodiments. However, the present disclosure is not limited to these embodiments. The present disclosure also encompasses applications of various modifications conceived of by those skilled in the art to these embodiments, and other modes constructed by combining part of the constituents in the embodiments within the range not departing from the gist of the present disclosure.

For example, a battery according to the present disclosure is applicable to a secondary battery such as an all-solid-state battery to be used in various electronic devices, automobiles, and the like.

What is claimed is:

1. A battery comprising:
a first electrode;
a second electrode;
a solid electrolyte layer disposed between the first electrode and the second electrode;
a temperature sensor; and
a first lead-out terminal, wherein
the temperature sensor includes at least one selected from the group consisting of a thermistor and a resistance temperature detector, and is in contact with the first electrode, and
the first lead-out terminal is in contact with the temperature sensor.

2. The battery according to claim 1, wherein
the first electrode includes a first current collector, and
the temperature sensor is in contact with the first current collector.

3. The battery according to claim 2, wherein the first current collector doubles as a terminal of the temperature sensor.

4. The battery according to claim 1, wherein
the temperature sensor includes the thermistor, and
the thermistor includes an operator of which electric resistance varies with a change in temperature.

5. The battery according to claim 4, wherein the operator is contained in the first electrode and is in contact with the first electrode.

6. The battery according to claim 4, wherein the thermistor is contained in the first electrode.

7. The battery according to claim 6, wherein the thermistor is disposed at center of the first electrode.

8. The battery according to claim 4, wherein the thermistor is in contact with the first electrode and with the solid electrolyte layer.

9. The battery according to claim 4, wherein the thermistor has a shape of a hollow frame.

10. The battery according to claim 4, wherein the thermistor has a laminated structure.

11. The battery according to claim 4, wherein the thermistor has a chip form.

12. The battery according to claim 4, wherein the thermistor includes an inner electrode.

13. The battery according to claim 4, wherein the thermistor includes a ceramic material.

14. The battery according to claim 13, wherein the ceramic material is an oxide ceramic.

15. The battery according to claim 14, wherein the oxide ceramic is a transition metal oxide containing at least one selected from the group consisting of Ni, Mn, Co, and Fe.

16. The battery according to claim 13, wherein the thermistor is an NTC thermistor.

17. The battery according to claim 16, wherein the ceramic material contains a crystal phase having a spinel structure as a major component.

18. The battery according to claim 1, further comprising:
a second lead-out terminal, wherein
the second lead-out terminal is in contact with the temperature sensor, and is lead out in a direction different from the first lead-out terminal.

19. The battery according to claim 1, wherein
the first electrode includes a first current collector, and
the temperature sensor is electrically coupled to the first current collector.

20. The battery according to claim 1, wherein the first electrode is a positive electrode.

21. A method for manufacturing a battery comprising:
fabricating a first electrode joined to a temperature sensor by forming the temperature sensor, a lead-out terminal in contact with the temperature sensor, and a first active material layer on a first current collector;
fabricating a second electrode;
forming a solid electrolyte layer on at least one electrode selected from the group consisting of the first electrode and the second electrode; and
joining the first electrode to the second electrode in such a way as to dispose the solid electrolyte layer in between.
